(19) United States
(12) Patent Application Publication
(10) Pub. No.: US 2004/0001434 A1
(43) Pub. Date: Jan. 1, 2004

(54) ETHERNET PACKET FLOW CONTROL METHOD AND ASSOCIATED APPLICATION APPARATUS

(76) Inventors: Jen-Kai Chen, Taipei Hsien (TW); Johnny Chao, Taiepi Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,830

(22) Filed: Feb. 24, 2003

(30) Foreign Application Priority Data
Jun. 28, 2002 (TW) 91114289

(51) Int. Cl. H04J 1/16; H04J 3/14

(52) U.S. Cl. 370/229; 370/412

(57) ABSTRACT

An Ethernet packet flow control method and associated application apparatus. A unicast flow control packet instead of a broadcast flow control packet is sent when the destination port is congested. The source port is informed to stop sending any packet to the congested port only. Therefore, overall performance of the transmission network is improved.

### CROSS REFERENCE TO RELATED APPLICATIONS

This application claims the priority benefit of Taiwan application serial no. 91114289, filed on Jun. 28, 2002.

### BACKGROUND OF INVENTION

1. Field of Invention

The present invention relates to an Ethernet packet flow control method and associated application apparatus.

2. Description of Related Art

Due to rapid progress in electronic technologies, computers and many other digital information devices prevail soon. To share resource, high speed network is essential for data exchange. Among various types of network systems, Ethernet has many advantages including easy to acquire and install with high data transmission rate. Recently, the data transmission rate of an Ethernet system has been upgraded from 10 Mbps to 100 Mbps and may reach up to 1 Gbps. As a result, the Ethernet switch (the switch for short) has become an essential component in network transmission.

In an Ethernet switch, in addition to a physical layer providing network connection ports, the Ethernet switch controller (switch controller for short) is required. In general, network switching performance depends on the switching algorithms. Because each connection port has a different transmission rate during package switching, the switch provides a buffer for holding network packets in order to prevent data loss. However, when the difference between the transmission rate of a source port and a destination port is huge, the buffering finally cannot hold all the transmission packets. Under such circumstance, the switch may issue a broadcast flow control packet through the source port to stop all remote ends from sending any data packets into the source port. Through this arrangement, the flow of data through the network can be controlled. However, this algorithm also prevents from the transmission of packets from the same source port to other destination ports. Ultimately, data transmission rate through the network is deteriorated.

### SUMMARY OF INVENTION

Accordingly, one object of the present invention is to provide an Ethernet packet flow control method and associated application apparatus capable of submitting a unicast flow control packet from a source port when insufficient buffer space occurs at the destination port. The unicast flow control packet informs the transmission source at the other end through the source port to suspend the transmission of packets to the destination port but permits the transmission of packets to other destination ports. Hence, network transmission efficiency is improved.

To achieve these and other advantages and in accordance with the purpose of the invention, as embodied and broadly described herein, the invention provides an Ethernet packet flow control method that can be used in an Ethernet switch having at least a source port and a destination port. First, a unicast packet is received from the source port. When the destination port of the unicast packet is congested, the link of the unicast packet link is replicated in the source port. When the source port needs to transmit the unicast packet, the unicast packet is converted into a unicast flow control packet for transmission.

This invention also provides an Ethernet switch controller for implementing the aforementioned Ethernet flow control method. The Ethernet switch controller receives an Ethernet packet from a source port and transmits the packet through a destination port. The Ethernet switch controller includes a buffer control unit, a forwarding control unit, a queue control unit and a plurality of port control units.

The buffer control unit controls the distribution and return of packets in its buffer space. The forwarding control unit inquires the destination port according to the Ethernet packet destination address and responds a destination port number. When the received Ethernet packet is a unicast packet and its destination port is congested, the forwarding control unit responds to the aforementioned destination port number and a source port number of the source port. The queue control unit establishes and holds the buffer links of the Ethernet packet in a queue that corresponds to the connection port according to the connection port number provided by the forwarding control unit. Through the queuing status of the corresponding queue, congestion status of the connection ports is provided. The port control units are coupled to the forwarding control unit, the buffer control unit and the queue control unit. The port control unit receives Ethernet packets from corresponding connection ports, transfers the Ethernet packets to buffer as instructed by the buffer control unit and transmits the Ethernet packets according to the links in the corresponding queue. When the Ethernet packet is a unicast packet and the source port that receives the unicast packet needs to transmit this unicast packet, the unicast packet is converted into a unicast flow control packet for transmission.

In one preferred embodiment of this invention, the destination address of the unicast flow control packet transmitted by the Ethernet switch controller is the destination address of the received packet. Furthermore, a register inside the Ethernet switch determines the pause time. When the destination port is congested, the received unicast packet is examined to determine if the packet is a flow control packet from other switches. If not, the links of the unicast packet are reproduced inside the source port.

In addition, the switch controller can be applied to an Ethernet switch. The switch further includes a buffer for holding Ethernet packets and a physical layer apparatus for providing a plurality of Ethernet connection ports. To be compatible with existing switches, the switch also includes a selection register so that either the flow control method as disclosed in this invention or the conventional flow control method is used.

Thus, using the Ethernet packet flow control method and associated application apparatus provided by the invention, the source port no longer broadcasts flow control packets when the buffer space for the destination port is full. Instead, a unicast flow control packet is transmitted. Hence, the transmission source at the other end is informed through the source port to stop transmitting any packets to the congested destination port. However, the sending of packets to non-congested destination ports is continued so that the performance of network transmission is little affected.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram of an Ethernet switch application system;

FIG. 2 is a diagram showing an Ethernet packet format;

FIG. 3 is a block diagram of an Ethernet switch according to one preferred embodiment of this invention; and

FIG. 4 is a block diagram of an Ethernet switch controller according to one preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

Please refer to FIG. 1 for the Ethernet switch application system. In FIG. 1, among the many users (not shown) of the system, there are two very high data rate digital subscriber line (VDSL) users, namely, user 140 and user 150. User 140 is a 64K user having a data transmission rate of 64Kbps while user 150 is a 2M user having a data transmission rate of 2Mbps. Thus, the transmission rates for the users 140 and 150 are very different. The two users obtain data service via the connection ports P5 and P6 of a second-tier switch 130, a first-tier switch 120 and a connection router 110. Since the 64K user 140 has a data transmission rate slower than the 2M user 150, the buffer space for port P5 of the second-tier switch 130 is fully occupied soon. As a result, the second-tier switch 130 issues a broadcast flow control packet from the connection port P4 to stop any packet transmission through the connection port P3 in the first-tier switch 120. This leads to the 2M user 150 and other users connected to the second-tier switch 130 being temporarily out of data service. If the out-of-service condition continues, congestion will happen in the first-tier switch 120 so that a broadcast flow control packet is issued from the connection port P2 to stop any packet transmission from the router 110. Hence, users connected to the first-tier switch 120 are also prohibited from obtaining any data service from the router 110.

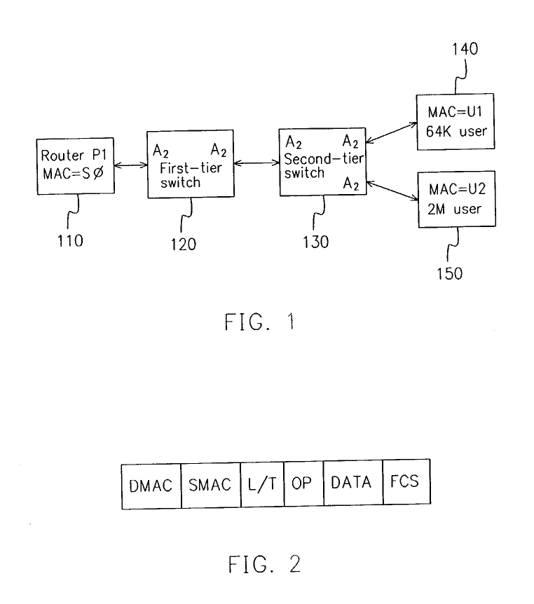

FIG. 2 is a diagram showing an Ethernet packet format. Each Ethernet packet includes a destination medium access control (DMAC) address field, a source medium access control (SMAC) address field, a length or type (L/T) field, an operation field (OP), a data (DATA) field and a frame control service (FCS) field. The destination medium access control (DMAC) address field and the source medium access control (SMAC) address field have a length of 6 bytes so that the addresses of different users are represented. When all 6 bytes in the DMAC field are FF, this indicates that the packet is a broadcast packet. The length or type (L/T) field and the operation code (OP) field both have a length of 2 bytes. The data (DATA) field has a variable length according to the type of data packet. The frame control service (FCS) field has a length of 4 bytes. When the length or type (L/T) field has a value of 8808 and that the operation code (OP) field has a value of 0001, this indicates the packet is a flow control packet. In this case, the two most significant bytes in the data (DATA) field represent the value of pause time. A larger pause time value implies a longer suspension of packet transmission. Since the services to all other users are also suspended, longer pause time results in a longer out-of-service period for all users.

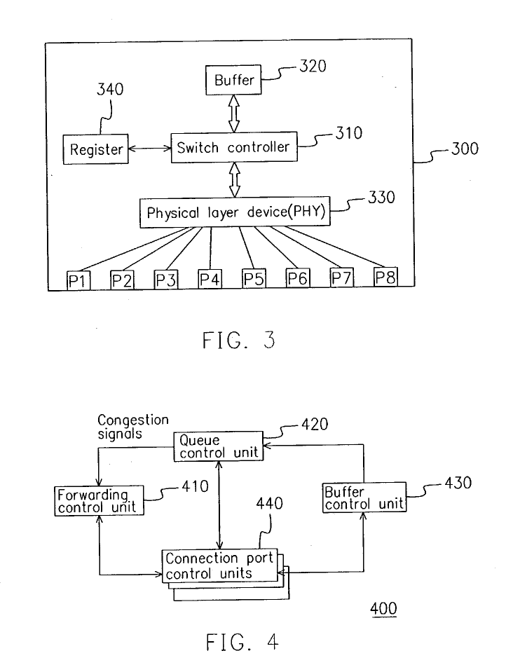

To resolve this problem, an Ethernet switch 300 having a system infrastructure as shown in FIG. 3 performs a different kind of flow control, according to one embodiment of this invention. The Ethernet switch 300 includes a buffer 320 for holding Ethernet packets, a physical layer device (PHY) 330 having a plurality of Ethernet connection ports and a switch controller 310 capable of performing the novel flow control method as disclosed in this invention. The switch controller 310 manages switching a plurality of Ethernet packets. If the destination port pointed to by the destination medium access control (DMAC) field of a unicast packet, such as the connection port P5 in FIG. 1, is congested, a unicast flow control packet is generated and transmitted back to the source port of the incoming unicast packet, such as the connection port P4 in FIG. 1. Hence, the transmission source is informed about the congestion to stop transmitting packets into the congested port for a predetermined period.

The length or type (L/T) field in the unicast flow control packet preferably has a value 8808 and the operation (OP) field preferably has a value 0001. The destination medium access control (DMAC) field preferably has a value equal to the source medium access control (SMAC) field such as S0 in FIG. 1 and the SMAC field preferably has a value equal to the DMAC field such as U1 in FIG. 1. This facilitates the transmission of packets to the router 110 through the connection port P3 in the first-tier switch 120 and the connection port P2. Thereafter, the router 110 may determine the congested user is the 64K user 140 according to the value U1 in the SMAC field of the unicast flow control packet and suspend the transmission of packets whose destination is the 64K user 140. Nonetheless, the transmission of packets destined for the 2M user 150 or other users is continued.

In addition, the Ethernet switch may include a register 340 for programming the pause time for the first two bytes of the data (DATA) field in the unicast flow control packet and for enabling the disclosed flow control method according to this invention. Persons skilled in the art may note that the register 340 can be integrated inside the switch controller 310. To prevent the first-tier switch 120 from sending another unicast flow control packet through the connection port P3 again due to congestion in the connection port P2, when the first-tier switch 120 receives the unicast flow control packet from the connection port P3, the unicast packet is determined whether or not it is a flow control packet and the destination port of the packet is congested. The aforementioned unicast flow control packet is transmitted from the source port only if the received packet is not a flow control packet.

FIG. 4 is a block diagram of an Ethernet switch controller according to one preferred embodiment of this invention. As shown in FIG. 4, the Ethernet switch controller 400 includes a buffer control unit 430, a forwarding control unit 410, a queue control unit 420 and a plurality of connection port control units 440. The buffer control unit 430 allocates and frees the buffer space. The forwarding unit 410 looks up the destination port according to the destination address in the Ethernet packet and responds with a connection port number. When the Ethernet packet is a unicast packet and the associated destination port is congested, the forwarding unit also responds with its destination port number and a source port number for the source port.

The queue control unit 420 establishes and records the buffer links of the Ethernet packet in a queue that corresponds to the connection port according to the connection port number(s) provided by the forwarding control unit 410. According to the utilization status of the corresponding queue, congestion status of the connection ports is provided so that the forwarding control unit 410 is capable of determining whether to respond the destination port number only or to respond both of the destination port number and the source port number. Thereafter, according to the responded connection port number, buffer links of packets are established and stored into queues of the corresponding connection ports.

When the connection port control unit 440 corresponding to the source port receives the packet, the packet is stored inside the buffer assigned by the buffer control unit 430. The connection port control unit 440 corresponding to the destination port transmits the packet according to the link corresponding to the queue. When the aforementioned respond result includes the source port number, the connection port control unit 440 corresponding to the source port transmits the received unicast packet according to the link in the corresponding queue. In the meantime, a unicast flow control packet must be generated, according to the content of the received unicast packet. The unicast flow control packet preferably has the aforementioned values in the DMAC field, the SMAC field, the L/T field and the OP field.

In addition, the Ethernet switch controller 400 preferably includes an internal register for setting the first two bytes (which represents the pause period) in the data (DATA) field of the unicast flow control packet and choosing whether to enable the unicast flow control as disclosed in this invention or the conventional flow control. The forwarding control unit 410 preferably is capable of determining if the received unicast packet is a flow control packet or not when the destination port is congested. The forwarding unit 410 responds an inquiry result including the source port of the received packet only if the unicast packet is not a flow control packet. This prevents from continuously generating flow control packets to be mutually transmitted when both connection ports are congested.

In the aforementioned description, the Ethernet packet received by the source port is a unicast packet. However, if the Ethernet packet is a multicast packet and one of the destination ports of the multicast packet is in a congestion state, this invention can be applied. In other words, a flow control packet having a destination address the same as the source address of the multicast packet is transmitted from the source port that receives the multicast packet. Furthermore, the source address of the packet is the destination address of the flow control packet in the multicast packet so that the packet transmission source suspends any transmission of the multicast packets having this destination address. Since the operating principle is similar to the aforementioned case, detailed description is omitted.

In conclusion, the flow control method of this invention only suspends packet transmission to congested destination ports. Since packets for other users are permitted to transmit, overall performance of the network is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An Ethernet packet flow control method for an Ethernet switch having at least a source port and a destination port, comprising the steps of:
receiving a unicast packet from the source port;
establishing a link according to the unicast packet for the source port when the destination port of the unicast packet is congested; and
generating and transmitting a unicast flow control packet, according to the unicast packet, in response to said link.

2. The flow control method of claim 1, wherein the destination address of the unicast flow control packet is the source address of the unicast packet and the source address of the unicast flow control packet is the destination address of the unicast packet.

3. The flow control method of claim 1, wherein the pause time of the unicast flow control packet is determined by a register in the Ethernet switch.

4. The flow control method of claim 1, wherein the unicast packet is determined whether or not the unicast packet is a flow control packet when the destination port of the unicast packet is congested, and the link is established for the source port only if the unicast packet is not a flow control packet.

5. An Ethernet switch controller for buffering an Ethernet packet received by a source port and transmitting the packet through a destination port, comprising:
a buffer control unit for allocating and freeing a buffer space;
a forwarding unit for looking up the destination number of the packet-transmitting destination port according to the destination address of the Ethernet packet, wherein the forwarding unit responds to the destination port number and a source port number of the source port if the destination port is congested and the Ethernet packet is a unicast packet;
a queue control unit for establishing a link for the buffered Ethernet packet to the queue that corresponds to the connection port according to the connection port number responded to by the forwarding unit; and
a plurality of port control units coupled to the forwarding unit, the buffer control unit and the queue control unit for receiving the Ethernet packet from a corresponding connection port, storing the Ethernet packet to the assigned buffering space inside the buffer control unit and transmitting the Ethernet packet according to the link corresponding to the queue, wherein the unicast packet is converted to a unicast flow control packet for transmission when the Ethernet packet is a unicast packet and the source port transmits the unicast packet.

6. The switch controller of claim 5, wherein the destination address of the unicast flow control packet is the source address of the Ethernet packet and the source address of the unicast flow control packet is the destination address of the Ethernet packet.

7. The switch controller of claim 5, wherein the controller further includes a register for storing a pause time value for the unicast flow control packet.

8. The switch controller of claim 5, wherein the unicast packet is checked to determine if the packet is a flow control packet when the destination port of the unicast packet is congested, and the link of the unicast packet is replicated inside the source port only if the unicast packet is not a flow control packet.

9. The switch controller of claim 5, wherein the controller further includes a register for holding a value that determines whether to enable or disable the response to the source port number when the destination port is congested.

10. An Ethernet switch, comprising:
a buffer for holding Ethernet packets;
a physical layer device for providing a plurality of Ethernet ports each having a source port and a destination port; and
a switch controller coupled to the buffer and the physical layer device for switching Ethernet packets and transmitting a unicast flow control packet via the source port when the destination port of the received unicast packet is congested.

11. The Ethernet switch of claim 10, wherein the destination address of the unicast flow control packet is the source address of the unicast packet and the source address of the unicast flow control packet is the destination address of the unicast packet.

12. The Ethernet switch of claim 10, wherein the switch further includes a register for setting the pause time in the unicast flow control packet.

13. The Ethernet switch of claim 10, wherein the unicast packet is checked to determine if the packet is a flow control packet when the destination port of the unicast packet is congested, and the link of the unicast packet is replicated inside the source port only if the unicast packet is not a flow control packet.

14. The Ethernet switch of claim 10, wherein the switch further includes a register for holding a value that determines whether to enable or disable the response to the source port number when the destination port is congested.

15. An Ethernet packet flow control method for a switch having at least a source port and a destination port, comprising the steps of:
receiving a unicast packet through the source port; and
transmitting a unicast flow control packet through the source port when the destination port in the unicast packet is congested.

16. The flow control method of claim 15, wherein the destination address of the unicast flow control packet is the source address of the unicast packet and the source address of the unicast flow control packet is the destination address of the unicast packet.

17. The flow control method of claim 15, wherein the switch further includes a register for setting the pause time in the unicast flow control packet.

18. The flow control method of claim 15, wherein the unicast packet is checked to determine if the packet is a flow control packet when the destination port of the unicast packet is congested, and the link of the unicast packet is replicated inside the source port only if the unicast packet is not a flow control packet.
